(19) United States
(12) Patent Application Publication
(10) Pub. No.: US 2012/0053951 A1
(43) Pub. Date: Mar. 1, 2012

(54) SYSTEM AND METHOD FOR IDENTIFYING A TARGETED PROSPECT

(75) Inventors: Craig Kowalchuk, Aurora (CA); Sheldon Smith, Toronto (CA); David Diamond, New York, NY (US)

(73) Assignee: TWENTY-TEN, INC., Toronto (CA)

(21) Appl. No.: 12/869,441

(22) Filed: Aug. 26, 2010

(51) Int. Cl. G06Q 99/00

(52) U.S. Cl. 705/1.1

(57) ABSTRACT

A method. The method includes receiving, at a computing device, data associated with a first plurality of consumers. The method also includes assigning a consumer of the first plurality of consumers to a first respective segments based on the received data, wherein the assigning is performed by the computing device. The method further includes calculating a goodness-of-fit score for the consumer of the first plurality of consumers for the first segment, wherein the calculating is performed by the computing device. Additionally, the method includes calculating a predicted goodness-of-fit score for a consumer of a second plurality of consumers for the first segment, the second plurality of consumers including at least the first plurality of consumers, wherein the calculating is performed by the computing device. The method further includes screening at least some of the second plurality of consumers, wherein the screening is performed by the computing device.

### CROSS-REFERENCE TO RELATED APPLICATION

This application is related to U.S. patent application Ser. No. 12/340,244, to U.S. patent application Ser. No. 10/821,516, now U.S. Pat. No. 7,742,072, and to U.S. patent application Ser. No. 09/511,971, now abandoned.

### BACKGROUND

This application discloses an invention which is related, generally and in various embodiments, to a system and method for identifying a targeted prospect.

In the quest for new business opportunities, there has been a growing proliferation of products and services seeking to more relevantly satisfy consumer needs. This has heightened competition and furthered a desire by marketers to look for tools that can more precisely identify optimal groups of consumers. Typical targeting methods have used historical information to determine what type of consumer had previously used product/service categories or brands. These factors were used to predict which consumers would likely buy in the future.

The majority of the previous approaches to target marketing prioritized consumers based on category and volume of brand usage. Such consumer targeting efforts are largely based on demographic and geodemographic factors. One approach has been to administer a survey to measure consumer usage levels pertaining to specific products, services and brands. The surveys have also been utilized to gather general demographic information for each respondent. Standard analysis techniques have been applied to study the results and identify optimal demographic segments for targeting marketing efforts. Geodemographic systems have been utilized to categorize the entire marketplace of consumers into a specific number of neighborhood types. These neighborhood types are typically classified according to demographic factors.

Unfortunately, targeting methods based on demographics or geodemographics have several drawbacks. For example, both methods assume that all consumers within a defined demographic or geodemographic sub-set are equally attractive. As such, these methods typically do not distinguish between individual consumers within the same group. In addition, neither method considers attitudinal variables, even though attitudinal variables greatly influence the future purchasing behavior of consumers. Because of these drawbacks, volume-only marketing techniques often do not meet the financial needs or specific marketing objectives of marketers.

To enhance the results generally achieved from the traditional targeting methodologies, some methodologies have also utilized attitudinal filtering. Attitudinal filtering is utilized to identify and reach groups of consumers who tend to “think alike” with respect to their brand and market segment. Examples of such groups, which are divided based on attitudinal variables, include early adopters of high tech consumer products, risk-averse buyers of investment securities, prestige-seeking buyers of luxury automobiles, fashion conscious clothes buyers, etc. Various examples of attitudinal filtering are described in U.S. Pat. No. 7,742,072, assigned to the assignee of the instant patent application.

The grouping of potential customers using attitudinal characteristics and definitions results in segments defined by more than mere demographics and the like. For example, rather than creating a group of potential luxury car buyers based solely on demographic information like income and past purchases, attitudinally-based segments look to the reasons for purchasing behavior. In this example, instead of merely identifying a group of potential luxury car buyers, the use of attitudinal filtering allows for the grouping of potential luxury car buyers based on the reason for wanting to purchase a luxury car (e.g., seeking prestige, professional appearance, etc.).

Even though utilizing attitudinal research to find the best prospects for a specific marketer is a quantum leap over the traditional geographic and geodemographic methods, known methods which utilize attitudinal research operate to identify prospects for a particular good or service, and do not take into consideration any retailers who ultimately sell the good or service directly to a consumer. Thus, known targeting methodologies would be significantly improved by making the targeting even more specific to include the manufacturer of the good as well as retailers who ultimately sell the good or service directly to the consumer.

### BRIEF DESCRIPTION OF THE DRAWINGS

Various embodiments of the invention are described herein in by way of example in conjunction with the following figures, wherein like reference characters designate the same or similar elements.

FIG. 1 illustrates various embodiments of a system;

FIG. 2 illustrates various embodiments of a computing system of the system of FIG. 1

FIG. 3 illustrates various embodiments of another system;

FIG. 4 illustrates various embodiments of a method; and

FIG. 5 illustrates various embodiments of another method.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

As described in more detail hereinbelow, aspects of the invention may be implemented by a computing device and/or a computer program stored on a computer-readable medium. The computer-readable medium may comprise a disk, a device, and/or a propagated signal.

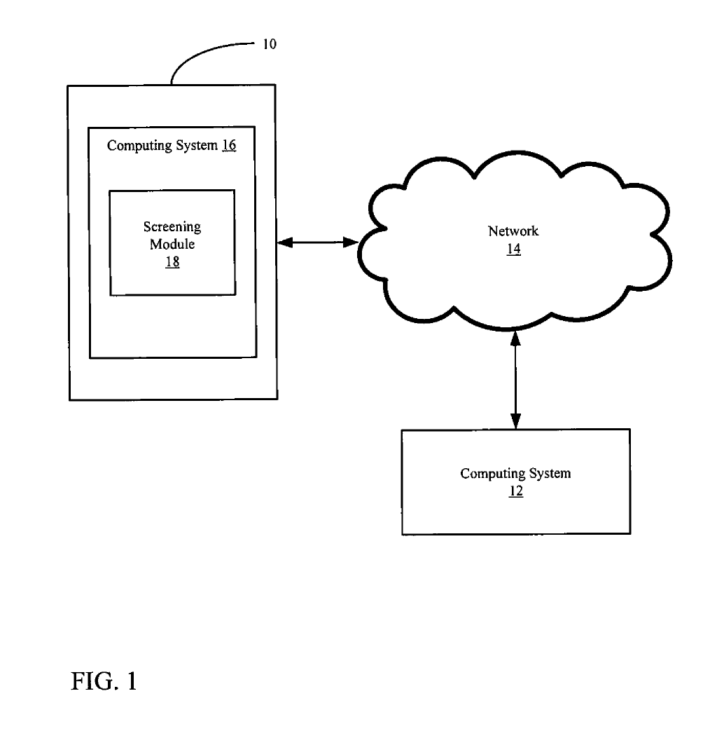

FIG. 1 illustrates various embodiments of a system 10. As explained in more detail hereinbelow, the system 10 may be utilized to determine a likelihood that a particular consumer will purchase a particular product (e.g., a good or a service) from a particular retailer. The particular consumer may be, for example, a consumer who was previously identified as a prime prospect for purchasing the particular product which is available at the particular retailer. As used herein, the term retailer means an entity (e.g., a person, a company, a corporation, etc.) that sells the particular item to a consumer. Thus, it will be appreciated that the term retailer encompasses both traditional stores and web-based stores.

As shown in FIG. 1, the system 10 may be communicably connected to a computing system 12 via a network 14. The computing system 12 may include any number of computing devices communicably connected to one another, and may be configured to identify a group of potential consumers who are targeted prospects for purchasing a particular product. As the system 10 is communicably connected to the computing system 12, a list of the identified group transmitted from the computing system 12 may be received by the system 10.

The network 14 may include any type of delivery system including, but not limited to, a local area network (e.g., Ethernet), a wide area network (e.g. the Internet and/or World Wide Web), a telephone network (e.g., analog, digital, wired, wireless, PSTN, ISDN, GSM, GPRS, and/or xDSL), a packet-switched network, a radio network, a television network, a cable network, a satellite network, and/or any other wired or wireless communications network configured to carry data. The network 14 may include elements, such as, for example, intermediate nodes, proxy servers, routers, switches, and adapters configured to direct and/or deliver data. In general, the system 10 may be structured and arranged to communicate with the computer system 12 via the network 14 using various communication protocols (e.g., HTTP, TCP/IP, UDP, WAP, WiFi, Bluetooth) and/or to operate within or in concert with one or more other communications systems.

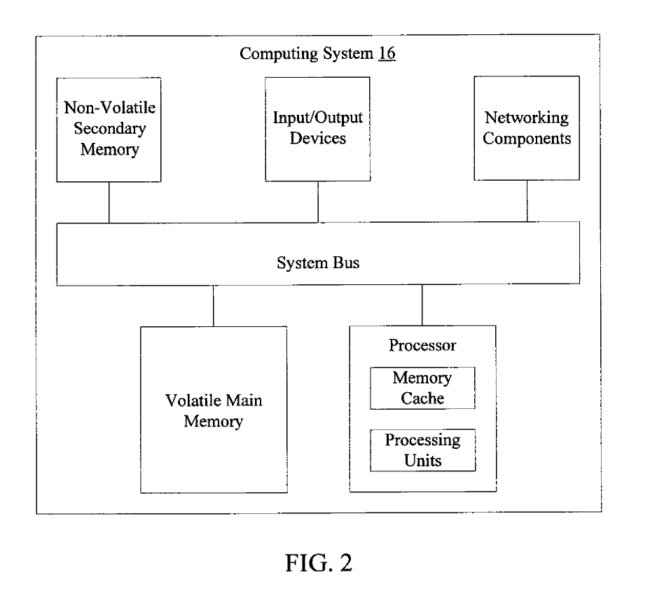

As shown in FIG. 1, the system 10 includes a computing system 16 and a screening module 18. The computing system 16 may be any suitable type of computing system that includes a processor (e.g., a server, a desktop, a laptop, etc.). For purposes of simplicity, the processor is not shown in FIG. 1. Various embodiments of the computing system 16 are described in more detail hereinbelow with respect to FIG. 2.

The screening module 18 is communicably connected to the processor. The screening module is configured to determine a likelihood that a particular consumer will visit a particular retailer. For a traditional store, the visit is manifested as a physical presence at or in the traditional store. For a web-based store, the visit is manifested as accessing the web site associated with the web-based store. Thus, when the system 10 receives a list of potential consumers who have been identified as targeted prospects for purchasing a particular product, the screening module 18 may be utilized to help determine, for each consumer on the list, a likelihood that the consumer will purchase the particular product at the particular retailer. Although only one screening module 18 is shown in FIG. 1, it will be appreciated that the system 10 may include any number of screening modules 18. Thus, the system 10 may be configured to determine, for each consumer on the list, different likelihoods for purchasing a given product at different retailers.

The screening module 18 may be configured as any number of different types of screening modules. For example, according to various embodiments, the screening module 18 may be configured as a geographic screening module, a behavioral screening module, an attitudinal screening module, combinations thereof, etc. Thus, it will be appreciated that, according to various embodiments, the screening module 18 is configured to provide more than one type of screening (e.g., geographic, behavioral, attitudinal, etc.) For such embodiments, the functionality of the screening module 18 may be implemented by a single screening module 18 or a plurality of different screening modules 18.

When the screening module 18 is configured as a geographic screening module, for a given consumer, the screening module 18 may analyze, for example, the distance from the consumer's home to the particular retailer, the estimated travel time from the consumer's home to the particular retailer, etc. to determine the likelihood that the given consumer will visit the particular retailer.

When the screening module 18 is configured as a behavioral screening module, for a given consumer, the screening module 18 may analyze, for example, the consumer's self-reported propensity to shop at a specific retailer to determine the likelihood that the given consumer will visit the particular retailer.

When the screening module 18 is configured as an attitudinal screening module, for a given consumer, the screening module 18 may analyze, for example, questionnaire answers which indicate that the given consumer is the type of person who favors a specific retailer to determine the likelihood that the given consumer will visit the particular retailer. For example, an answer such as “saving money is important to me” may indicate that the given consumer favors shopping at Wal-Mart whereas an answer such as “being stylish at a fair price is important to me” may indicate that the given consumer favors shopping at Target.

The screening module 18 may be implemented in hardware, firmware, software and combinations thereof. For embodiments utilizing software, the software may utilize any suitable computer language (e.g., C, C++, Java, JavaScript, Visual Basic, VBScript, Delphi) and may be embodied permanently or temporarily in any type of machine, component, physical or virtual equipment, storage medium, or propagated signal capable of delivering instructions to a device. The screening module 18 (e.g., software application, computer program) may be stored on a computer-readable medium (e.g., disk, device, and/or propagated signal) such that when a computer reads the medium, the functions described herein are performed.

FIG. 2 illustrates various embodiments of the computing system 16. The computing system 16 may be embodied as one or more computing devices, and includes networking components such as Ethernet adapters, non-volatile secondary memory such as magnetic disks, input/output devices such as keyboards and visual displays, volatile main memory, and a processor. Each of these components may be communicably connected via a common system bus. The processor includes processing units and on-chip storage devices such as memory caches.

According to various embodiments, the computing system 16 includes one or more modules which are implemented in software, and the software is stored in non-volatile memory devices while not in use. When the software is needed, the software is loaded into volatile main memory. After the software is loaded into volatile main memory, the processor reads software instructions from volatile main memory and performs useful operations by executing sequences of the software instructions on data which is read into the processor from volatile main memory. Upon completion of the useful operations, the processor writes certain data results to volatile main memory.

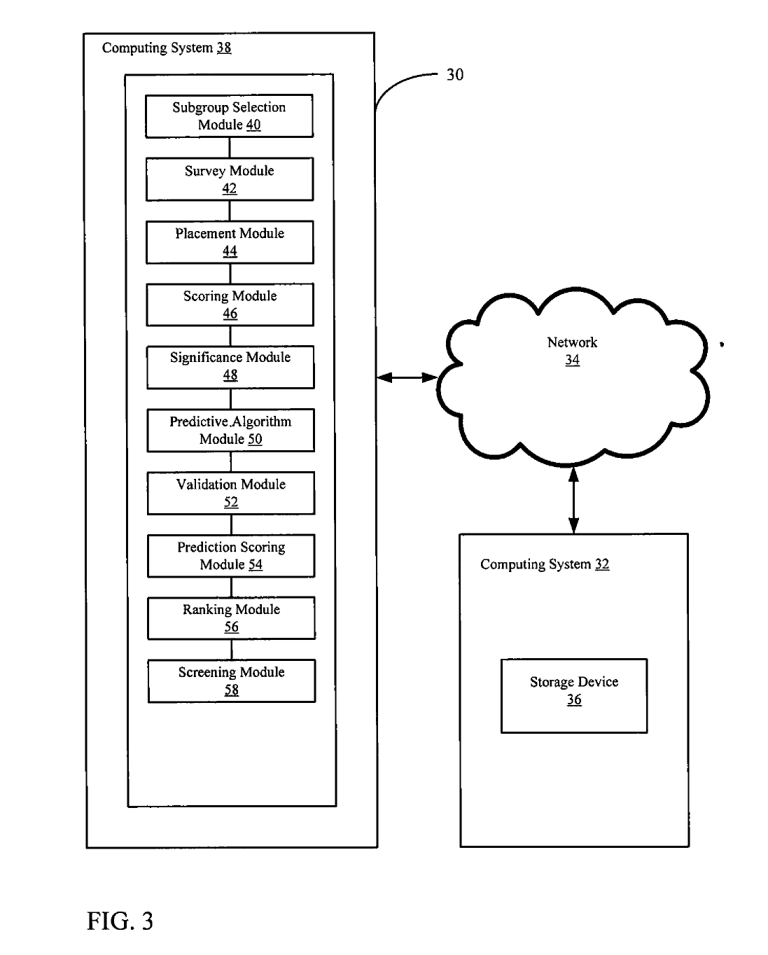

FIG. 3 illustrates various embodiments of a system 30. As explained in more detail hereinbelow, the system 30 may be utilized to determine a likelihood that a particular consumer will purchase a particular product at a particular retailer. As shown in FIG. 3, the system 30 may be communicably connected to a computing system 32 via a network 34. The computing system 32 may include any number of computing devices communicably connected to one another. The network 34 may be similar to or identical to the network 14 described hereinabove. The system 30 is communicably connected to a storage device 36. According to various embodiments, the system 30 is communicably connected to the storage device 36 via the network 34. As shown in FIG. 3, according to various embodiments, the storage device 36 may form a portion of the computing system 32.

The storage device 36 includes a database having information regarding potential consumers, and such information may be present for any number of potential consumers (e.g., the information is appended to individual records/rows of data in a database table). For example, the information may be present for approximately 85,000,000 potential consumers. The information includes a plurality of data variables for each of the potential consumers, including non-attitudinal variables, and such consumer data variables may relate to many different types of data. Non-attitudinal variables are objective variables of each consumer that are not based on the purchasing attitudes of the consumer. Such non-attitudinal variables include, for example, gender, income, age, home-ownership, parenthood, education, geographic location, ethnicity, etc. Non-attitudinal variables do not include attitudinal variables such as, for example, brand loyalty, price sensitivity, importance of quality, preference for style, and attraction to brand proposition. The data may be organized into categories such as, for example, lifestyle, demographic, financial, home-ownership, vehicle registration, consumer purchase behavior variables, etc. As the system 30 is communicably connected to the storage device 36, a list of potential consumers, including information associated with the customers, may be accessed by the system 30.

The system 30 includes a computing system 38. The computing system 38 may be any suitable type of computing device that includes a processor (e.g., a server, a desktop, a laptop, etc.). For example, the computing system 38 may be similar to or identical to the computing system 16 described hereinabove. For purposes of simplicity, the processor is not shown in FIG. 3.

According to various embodiments, the system 30 includes the following modules: a subgroup selection module 40, a survey module 42, a placement module 44, a scoring module 46, a significance module 48, a predictive algorithm module 50, a validation module 52, a prediction scoring module 54, a ranking module 56, and a screening module 58. Each of the modules 40-58 may be communicably connected to the processor and to one another.

The subgroup selection module 40 is configured to select a subgroup of consumers from a list of consumers. The list of consumers may be accessed, for example, from the database of the storage device 36. The subgroup can be of any size as long it is less than the number of consumers on the list. The subgroup selection module 40 may operate to randomly select the subgroup from the list of consumers. According to various embodiments, the subgroup selection module 40 may also be configured to pre-sort the list of consumers in order to select individuals for the subgroup based on pre-selected variables. The pre-selected variables may be, for example, objective variables. For example, the subgroup selection module 40 may be configured to randomly select a subgroup of individuals in the group of males between 15-24 years of age.

The survey module 42 is configured to create (1) attitudinal statements and/or (2) questions (e.g., behavioral and future predispositions questions) which are to be presented to the consumers selected for the subgroup. In general, the created attitudinal statements and/or questions serve to elicit a quantitative response from the subgroup members when the attitudinal statements and/or questions are presented to the subgroup members. Stated another way, the attitudinal statements and/or questions are formatted to effectively measure the degree of attitudinal commitment present in each survey respondent. According to various embodiments, the survey module 42 may also be configured to present the attitudinal statements and/or questions and/or receive the responses thereto. According to various embodiments, the survey module 42 may be external to the system 30 (e.g., the survey module 42 resides at the computing system 32).

The placement module 44 is configured to assign an individual subgroup member (i.e., information associated with the individual subgroup member) to a specific segment (attitudinal and/or behavioral). The placement module 44 may be configured to assign the subgroup member to the specific segment in a number of different ways.

According to various embodiments, a given segment may be defined based on an ideal consumer target (e.g., consumers who are looking for a very soft bathroom tissue and are more likely to shop at a particular retailer), and the placement module 44 may be configured to assign the subgroup member to the defined segment based on gathered attitudinal and/or behavioral data. The gathered data may be gathered via the responses to the attitudinal statements and/or questions, or via any other suitable means. For example, suppose the following two questions are asked to the consumers selected for the subgroup:

(1) On a scale of 1 to 5, where 1 represents “not at all important” and 5 represents “extremely important”, how important is softness when you consider which bathroom tissue to buy for your family?; and

(2) On a scale of 1 to 5, where 1 represents “not at all likely” and 5 represents “extremely likely”, how likely are you to visit a Walmart store within the next two months? The placement module 44 may analyze the responses to the questions, then assign the consumers who responded to each question with either 4 or 5 to the segment “consumers who are looking for a very soft bathroom tissue and are more likely to shop at a Walmart”.

According to other embodiments, the placement module 44 may be configured to employ factor analysis and cluster analysis to assign the individual subgroup members to respective segments. For such embodiments, the placement module 44 may be configured to identify key attitudinal and/or behavioral dimensions based on gathered data, define one or more distinct segments based on the identified dimensions, then assign the subgroup members to the respective segments. The placement module 44 may be configured to identify any number of key dimensions and to utilize any number of the identified key dimensions to define any number of distinct segments. The gathered data may be gathered via the responses to the attitudinal statements and/or questions, or via any other suitable means.

In general, for such other embodiments, the placement module 44 operates to identify responses to individual attitudinal statements and/or questions which are correlated, and to group together such responses to form the dimensions. Correlation amongst various responses may be determined by looking at exact matches of responses between several subgroup members. The placement module 44 may then operate to define the distinct segments based on the dimensions, then to apply various statistical techniques to assign the subgroup members to the respective segments. According to various embodiments, the subgroup members are assigned to a given segment by grouping together individuals whose survey response patterns are characterized by at least two elements of homogeneity. Any number of elements of homogeneity may be employed, as judged against the total surveyed population. According to various embodiments, the placement module 44 may also be configured to identify groups of individuals whose response patterns are as mutually exclusive as possible from members of other segments.

The scoring module 46 is configured to calculate a goodness-of-fit score for each individual in the subgroup for each segment. Thus, if there are ten segments, the scoring module 46 will calculate ten goodness-of-fit scores for each subgroup member. In general, a given goodness-of-fit score is based on the degree of fit between a given subgroup member and a given segment, and the respective goodness-of-fit scores calculated by the scoring module 46 serve to illustrate distinctions between the various subgroup members. Thus, although a number of subgroup members may be assigned to a given segment, the respective degrees of fit between the given segment and all subgroup members may vary.

According to various embodiments, the scoring module 46 is configured to calculate a goodness-of-fit score based on combined data from different survey questions. For example, a user may want to identify consumers who are really attracted to buying the softest bathroom tissue (M1), have expressed a high likelihood to buy a particular brand with a $1 coupon (M2), and are likely to buy the product at a Walmart (M3). In order to facilitate the combining of different questions/statements that have different response scales, the responses may be normalized to avoid potential scale-of-size influence. Once the responses are normalized, various linear and exponential weighting schemes can then be used to combine responses to questions that pertain to the target segment in order to emphasize specific target elements and define a goodness-of-fit score.

For example, according to various embodiments, a given goodness-of-fit score may be represented by any of the following:

Goodness-of-fit=(M1+M2+M3)/3

Goodness-of-fit=[(W1*M1)±(W2*M2)+(W3*M3)/3

Goodness-of-fit=“Retailer X”*(M1+M2)/2

where M1-M3 are as described above, W1-W3 are weights such that their sum is zero, and retailer X represents how likely a consumer is to shop at retailer X.

The significance module 48 is configured to determine which non-attitudinal variables (independent variables) that are appended to the database records of the subgroup members are strongly correlated to the goodness-of-fit scores (dependent variables) for a given target segment. The significance module 48 is configured to take into account the statistical reliability of the correlation. For example, the reliability of the statistical correlation may be determined based on the sample size of the survey file being analyzed (that includes the goodness-of-fit scores), and may also take into account the cross-correlation between different independent variables. According to various embodiments, only those non-attitudinal variables determined to be strongly correlated to the goodness-of-fit scores are utilized to generate predictive algorithms as described in more detail hereinbelow. The significance module 48 may also be configured to determine the correlation strength (significance) for one or more tolerance levels.

According to various embodiments, the non-attitudinal variables that have been appended to the database records of the subgroup members may be classified prior to the correlation performed by the significance module 48. The classifications may be performed manually or by a module of the system 30. For example, for such embodiments, the non-attitudinal variables may be classified as either (1) continuous non-attitudinal variables (e.g., can be expressed on a continuous scale such as age, percentages, $ amounts, etc.), (2) dichotomous non-attitudinal variables (e.g., are expressed as on or off, one or zero, etc.), or (3) categorical non-attitudinal variables (e.g., are nominal or descriptive such as type of house, area of country, occupation, etc.). For such embodiments, the significance module 48 is configured to take into account the type or class of each variable each independent variable represents (e.g., binary, etc.), and output a set of independent “candidate” modeling variables that are considered statistically significant or meaningful in their strength of correlation or relationship with the dependent variable (goodness-of-fit) score. The significance module 48 may utilize Pearson Correlation for the continuous variables, and one-way analysis of variance (ANOVA) for dichotomous variables and categorical variables.

According to various embodiments, the significance module 48 may be further configured to combine or modify certain individual non-attitudinal variables (independent variables) to create a shadow or composite variable that represents a linear or smoother relationship between each categorical variable used to create the composite variable and the specific dependent variable. This functionality operates to stabilize and enhance the potential utility of specific non-attitudinal variables whose statistical significance is considered too unstable due to smaller sample sizes experienced in specific projects. The product of this functionality is a composite variable which comprises a combination of individual non-attitudinal variables (which are highly correlated to each other as well as highly correlated with the dependent variable). The combining may be performed in an additive way, where subgroup members who have more than one of the highly correlated non-attitudinal characteristics (from the set which is being composited) are assigned a higher value.

For example, assume that there are three non-attitudinal variables (hair color, month of birth and foot width) that appear to be highly correlated with the dependent variable (goodness-of-fit score). These may be considered categorical independent variables. Examples of how the composite variable would be generated for two different subgroup members are shown below:

Subgroup member A

| | | |
|---|---|---|
| hair color | blonde | 0.70 |
| month of birth | October | 0.67 |
| foot width | DD | 0.24 |
| additive composite variable | | 1.61 |

Subgroup member B

| | | |
|---|---|---|
| hair color | blonde | 0.70 |
| month of birth | September | 0.10 |
| foot width | AAA | 0.24 |
| additive composite variable | | 1.04 |

It will be appreciated that the methodology for combining categorical variables with continuous variables, categorical variables with dichotomous variables, etc. to generate composite variables will differ from the additive examples shown above.

The predictive algorithm module 50 is configured to generate, for each segment, an algorithm which predicts the goodness-of-fit scores previously calculated for each of the subgroup members who are assigned to that segment. Thus, the predictive algorithm module 50 may be utilized to generate a different algorithm for each segment. According to various embodiments, the predictive algorithm module 50 may be configured to generate more than one algorithm per segment. The respective algorithms may be generated in any suitable manner.

According to various embodiments, the database records associated with the subgroup members are separated into first and second portions. The size of the first and second portions are generally different, and the respective sizes may differ by any amount. For example, according to some embodiments, the first portion represents 66% of all the database records of the subgroup members and the second portion represents 34% of all the database records of the subgroup members. For purposes of simplicity, the first portion will hereinafter be referred to as the larger portion and the second portion will hereinafter be referred to as the smaller portion. The predictive algorithm model 50 utilizes the segment specific non-attitudinal variables that are determined as “candidate” variables (e.g., by the significance module 48) of the larger portion of the database records to generate the respective algorithms. According to various embodiments, the previously calculated goodness-of-fit scores of the subgroup members associated with the larger portion of the database records are employed as dependent variables, then regression techniques (e.g., step-wise linear regression, logistic regression, etc.) are applied to realize the respective algorithms. According to various embodiments, the predictive algorithm module 50 may be external to the system 30 (e.g., the predictive algorithm module 50 resides at the computing system 32).

The validation module 52 is configured to determine whether the performance of a predictive algorithm generated by the algorithm prediction module 50 is sufficiently acceptable. The predictive algorithm may be considered sufficiently acceptable (validated) when its application to the larger portion produces an improvement (e.g., % lift) in identifying consumers with the target segment profile or traits that a client/brand is looking for which is comparable to an improvement produced by its application to the smaller portion. According to various embodiments, the improvements determined for the larger portion and the improvements determined for the smaller portion may be considered comparable if they are within a certain range of tolerance (e.g., + or −20%).

According to various embodiments, the validation module 52 is configured to perform the following actions: (1) apply the predictive algorithm to the larger portion of the database records to generate goodness-of fit scores for each subgroup member associated with the larger portion; (2) rank each subgroup member (e.g., from high to low) based on the goodness-of-fit score determined by the predictive algorithm; (3) divide the larger portion into a plurality of equal-sized groupings (e.g., ten groupings); (4) determine the percentage of subgroup members who share the attitudinal/behavioral profile being targeted; (5) determine the improvement (e.g., % lift) in identifying consumers with the target segment profile or traits that a client/brand is looking for; (6) repeat steps (1)-(5) using the smaller portion; and (7) compare the improvement for the larger portion with the improvement for the smaller portion.

The prediction scoring module 54 is configured to calculate, for each segment, a predicted goodness-of-fit score for each consumer listed in the database of the storage device 36. Thus, the prediction scoring module 54 may be utilized to calculate a plurality of predicted goodness-of-fit scores for each consumer listed in the database of the storage device 36. In general, the prediction scoring module 54 utilizes the segment specific algorithms generated by the predictive algorithm module 50 to calculate the respective segment specific predicted goodness-of-fit scores. Thus, for embodiments where more than one algorithm per segment was generated, more than one predicted goodness-of-fit score per segment may be calculated for a given consumer listed in the database. According to various embodiments, the higher a given predicted goodness-of-fit score, the better the fit within the particular segment.

The ranking module 56 is configured to rank, on a segment by segment basis, the consumers listed in the database based on the predicted goodness-of-fit scores calculated by the prediction scoring module 54. According to various embodiments, the ranking may be ordered from highest to lowest within a given segment. According to other embodiments, the ranking may be ordered from lowest to highest within a given segment. It will be appreciated that a first ranking based on predicted goodness-of-fit scores calculated using a first algorithm for a given segment may be different than a second ranking based on predicted goodness-of-fit scores calculated using a second algorithm for the given segment. In general, the rankings indicate the relative likelihood that a given consumer who has a self-reported propensity to shop at a particular retailer will purchase a particular product.

The screening module 58 is configured to determine a likelihood that a particular consumer will visit a particular retailer, and may be similar or identical to the geographic screening module 18 described hereinabove. For embodiments where the screening module 58 is provided with a targeted list of consumers who have a self-reported propensity to shop at a particular retailer and are likely to purchase a particular product, it will be appreciated that the screening module 58 essentially determines, for each consumer on the targeted list, a likelihood that the consumer will purchase the particular product at the particular retailer.

The modules 40-58 may be implemented in hardware, firmware, software and combinations thereof. For embodiments utilizing software, the software may utilize any suitable computer language (e.g., C, C++, Java, JavaScript, Visual Basic, VBScript, Delphi) and may be embodied permanently or temporarily in any type of machine, component, physical or virtual equipment, storage medium, or propagated signal capable of delivering instructions to a device. The modules 40-58 (e.g., software application, computer program) may be stored on a computer-readable medium (e.g., disk, device, and/or propagated signal) such that when a computer reads the medium, the functions described herein are performed.

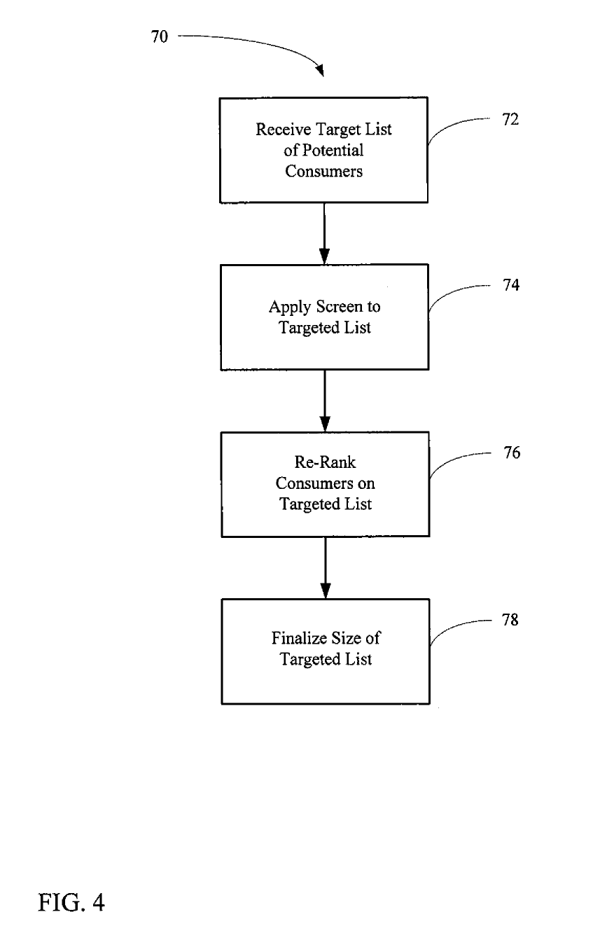

FIG. 4 illustrates various embodiments of a method 70. As explained in more detail hereinbelow, the method 70 may be utilized to determine a likelihood that a particular consumer will purchase a particular product at a particular retailer. According to various embodiments, the method 70 may be implemented by the system 10 or the system 30. For purposes of simplicity, the method 70 will be described in the context of its implementation by the system 10. However, it will be appreciated that the method 70 may be implemented by any number of different systems.

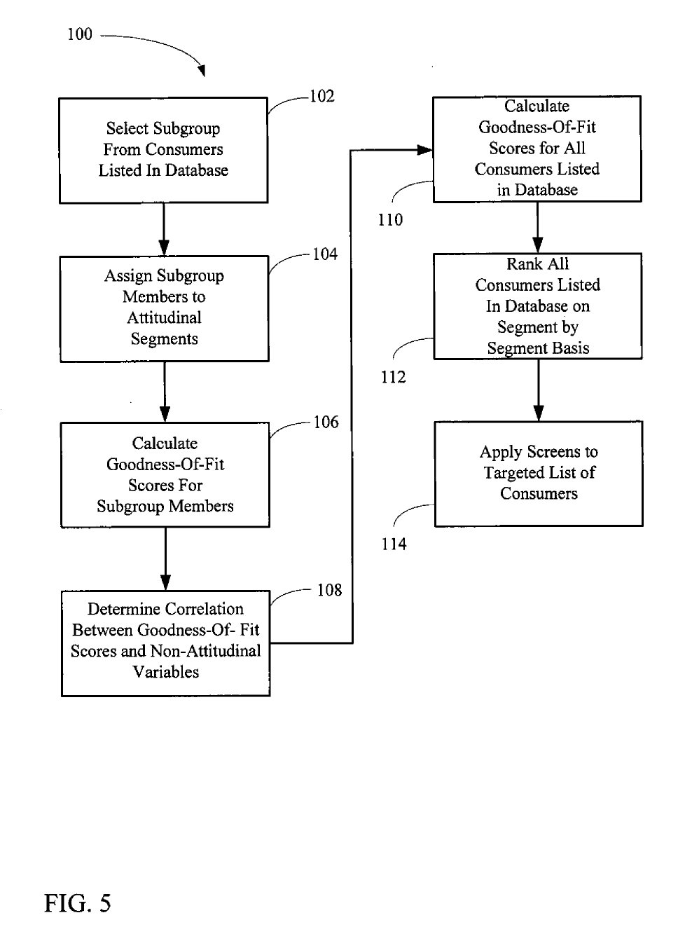

Prior to the start of the process, a targeted list of potential consumers is determined, then forwarded to the computing system 16. The targeted list may include any amount of information associated with the respective consumers (e.g., demographic, geographic, attitudinal, behavioral, etc.), may be determined in any suitable manner, and the determination may be based on any number of different methodologies (e.g., attitudinal variables, behavioral variables, etc.). For example, according to various embodiments, the targeted list may be determined as explained in more detail hereinbelow with respect to FIG. 5. The targeted list may include any number of potential consumers. According to various embodiments, the targeted list indicates a group of consumers who are prime prospects to purchase a particular product, and indicates for each consumer on the list, a likelihood that the consumer will purchase the particular product.

The process starts at block 72, where the computing device 16 receives the targeted list of potential consumers. For purposes of simplicity, the rest of the process 70 will be described as if the targeted list received at block 72 indicates a group of consumers who are prime prospects to purchase a particular product (e.g., window shades), and indicates for each consumer on the list, a likelihood that the consumer will purchase the particular product. Each consumer on the targeted list may also be ranked according to their respective likelihoods of purchasing the particular product.

From block 72, the process advances to block 74, where the screening module 18 determines, for each consumer on the targeted list, a likelihood that the consumer will visit a particular retailer (e.g., Home Depot). According to various embodiments, the screening module 18 may determine the respective likelihoods for a plurality of different retailers. The screening module 18 may determine the likelihood that a given consumer will visit the particular retailer in any suitable manner. For example, according to various embodiments, the likelihood may be determined by applying a screen (e.g., a filter) to the targeted list.

The screen may be any suitable type of screen. For example, according to various embodiments, the screen may be a geographic screen such as the distance from the consumer's home to the particular retailer, the time it takes a consumer to travel from his/her home to the particular retailer, etc. In general, the shorter the distance or travel time to the retailer, the more likely the consumer will shop at the particular retailer. According to other embodiments, the screen may be a behavioral screen such as a consumer's self-reported propensity to shop at the particular retailer. In general, the higher the propensity, the more likely the consumer will purchase the particular product at the particular retailer. According to yet other embodiments, the screen may be an attitudinal screen such as questionnaire answers which indicate that the consumer favors a particular retailer more than another retailer. In general, the more the consumer favors the particular retailer over other retailers, the more likely the consumer will purchase the particular product at the particular retailer.

Because the targeted list received at block 72 indicated, for each consumer on the list, the likelihood that the consumer will purchase a particular product, and because the screening module 18 determines, for each consumer on the list, the likelihood that a consumer will visit a particular retailer, it will be appreciated that following the completion of block 72, information is available which effectively indicates, for each consumer on the list, the likelihood that the consumer will purchase the particular product at the particular retailer.

According to various embodiments, the process may advance from block 74 to block 76, where the targeted list received at block 72 is re-ranked based on the respective likelihoods determined for each consumer at block 74. The re-ranking of the targeted list may be performed by the computing device 16, by the screening module 18, combinations thereof, etc. According to other embodiments, the re-ranking may be performed external to the system 10 (e.g., by the computer system 12). According to various embodiments, the re-ranking is performed by comparing the respective likelihoods determined for each consumer at block 74 to a threshold. The threshold may be predetermined, may vary by product, may vary by retailer, and may vary over time. According to other embodiments, the re-ranking is further performed by also comparing the respective likelihoods indicated in the targeted list received at block 72 (i.e., the likelihood that a given consumer will shop for a particular product) to a second threshold. The second threshold may be predetermined, may vary by product, and may vary over time.

According to various embodiments, the process may advance from block 76 to block 78, where the size of the targeted list is finalized based on the re-rankings. According to various embodiments, the number of consumers on the targeted list is reduced at block 76 from the number originally on the targeted list received at block 72. According to other embodiments, the final number of consumers on the targeted list remains the same as the number originally on the targeted list received at block 72. The finalization of the size of the targeted list (e.g., the reduction in the number of consumers on the list) may be performed by the computing system 16, by the screening module 18, combinations thereof, etc. According to other embodiments, the re-ranking may be performed external to the system 10 (e.g., by the computer system 12). The process described at blocks 72-78 may be repeated any number of times.

FIG. 5 illustrates various embodiments of another method 100. As explained in more detail hereinbelow, the method 100 may be utilized to determine a likelihood that a particular consumer will purchase a particular product at a particular retailer. According to various embodiments, the method 70 may be implemented by the system 30. For purposes of simplicity, the method 100 will be described in the context of its implementation by the system 30. However, it will be appreciated that the method 100 may be implemented by any number of different systems.

Prior to the start of the process, a large amount of information associated with potential consumers is developed and organized as a database residing at storage device 36. In general, the information includes a plurality of data variables for each potential customer. The information may include any number of such data variables, and the data variables may relate to any number of different types of data. The data variables may be organized into categories such as, for example, lifestyle, demographic, financial, home-ownership, vehicle registration, consumer purchase behavior variables, etc. A person skilled in the art will appreciate that the database may include many different types of consumer data variables. For example, according to various embodiments, the developed database has lifestyle and demographic variables for over 85,000,000 individual consumers.

Additionally, attitudinal attributes which are important to a particular manufacturer, distributor retailer, etc. are determined. According to other embodiments, the attitudinal attributes may be determined after the start of the process. Examples of such attitudinal attributes include, but are not limited to: (1) importance of quality over price; (2) importance of price sensitivity in home computers; (3) importance of brand name appeal to the consumer; (4) preference for powerful cars over economy cars; (5) brand name loyalty; (6) importance of value/price; (7) perceived status/image of customer for using or wearing a brand name product; (8) importance of style/fashion; (9) technology loving/hating; (10) importance of convenience in selecting a retailer; etc. It will be appreciated that other attributes that are based on the attitudes that consumers have when making the decision to purchase products or services may also be determined to be important attitudinal attributes. Thus, it will be appreciated that the attitudinal attributes determined to be important are not based on purchase volume history but rather on the attitudes that consumers have, and to those which are related to future purchase decisions.

Also prior to the start of the process, a survey is created which includes attitudinal statements/questions which are based on the attitudinal attributes determined to be important to the particular manufacturer, distributor retailer, etc. According to other embodiments, the survey may be created after the start of the process. As described in more detail hereinbelow, the attitudinal statements/questions are eventually presented to a plurality of potential consumers. The survey may be conducted, for example, by presenting various attitudinal statements/questions to the potential consumers and asking them, for each presented attitudinal statement/question, to rate their level of agreement on a 5 point scale, where 1 represents “completely disagree” and 5 represents “completely agree”. The survey may also be conducted, for example, by presenting a set of attitudinal statements to the potential consumers, and asking them to identify which statement is most important in their purchase decision and which one is least. According to various embodiments, the survey module 42 is utilized to generate the attitudinal statements/questions, present them to the potential consumers, and/or receive the responses from the potential consumers.

The process starts at block 102, where the subgroup selection module 40 selects a plurality of names of potential consumers from the information included in database. Collectively, the selected names represent a subgroup of all the potential consumers who have information associated with them included in the database. The subgroup selection module 40 may select the subgroup in any suitable manner. For example, according to various embodiments, the subgroup selection module 40 randomly selects the subgroup from the overall group of consumers who have information associated with them included in the database. The selected subgroup may be of any suitable size. For example, according to various embodiments, the subgroup includes approximately 20,000 people. According to various embodiments, the subgroup selection module 40 may also pre-sort the overall group of potential customers based on pre-selected variables (e.g., objective variables) before selecting the subgroup. For example, the subgroup selection module 40 may pre-sort the overall group of potential customers into potential customers who are males between the ages of 15-24, then randomly select the subgroup from the pre-sorted group.

From block 102, the process advances to block 104, where the placement module 44 assigns the subgroup members (e.g., assigns information associated with the subgroup members) to respective segments. Each individual subgroup member is assigned to a specific segment. Thus, it will be appreciated that some subgroup members are assigned to a first segment, other subgroup members are assigned to a second segment, etc.

From block 104, the process advances to block 106, where the scoring module 46 calculates goodness-of-fit scores for the subgroup members. A goodness-of-fit score is calculated for each individual in the subgroup for each segment. According to various embodiments, a given goodness-of-fit score is based on the degree of fit between a given subgroup member and a given segment. Thus, the respective goodness-of-fit scores calculated by the scoring module 46 may serve to illustrate distinctions between the various subgroup members. For example, the respective goodness-of-fit scores may serve to illustrate distinctions between subgroup members who fit perfectly in a given segment, fit very closely in a given segment, do not fit very closely in a given segment, those who have attitudes/behaviors opposite to members in a given segment, etc.

From block 106, the process advances to block 108, where the significance module 48 determines which non-attitudinal variables that are appended to the database records of the subgroup members are strongly correlated to the goodness-of-fit scores for a given target segment. This determination identifies a set of non-attitudinal variables that are considered statistically significant or meaningful in their strength of correlation or relationship with the goodness-of-fit scores.

According to various embodiments, after the correlations amongst the non-attitudinal variables and the goodness-of-fit scores are determined at block 108, the predictive algorithm module 50 may utilize the segment specific non-attitudinal variables to generate one or more predictive algorithms for each segment. The generated algorithms operate to predict the goodness-of-fit scores previously calculated for each of the subgroup members at block 106.

The predictive algorithm module 50 may generate the algorithms in any suitable manner. According to various embodiments, the predictive algorithms are generated based on values determined for various non-attitudinal segments. The predictive algorithm module 50 may utilize non-attitudinal variables as the independent variables and the calculated goodness-of-fit scores of the individual subgroup members as dependent variables to generate the algorithms. Table 1 shows nine exemplary non-attitudinal variables that could apply to a given segment. These non-attitudinal variables may be included in the database.

TABLE 1

| | | Value |
|---|---|---|
| Name of Non-Attitudinal | | for an |
| Variable | Variable Configuration | Individual |
| 1) Value of home | Expressed as an index: | 147 |
| | ($ value of individual's | |
| | home/average value of | |
| | neighborhood homes × 100) | |
| 2) Time in current residence | Years | 5 |
| 3) Purchase beauty aids | “yes” = 1; “no” = 0 | 0 |
| 4) Subscribe to a fitness | “yes” = 1; “no” = 0 | 1 |
| magazine | | |
| 5) Read the Bible | “yes” = 1; “no” = 0 | 0 |
| 6) Surf the internet | “yes” = 1; “no” = 0 | 1 |
| 7) Purchase by mail order | “yes” = 1; “no” = 0 | 0 |
| 8) Donate to environmental | “yes” = 1; “no” = 0 | 0 |
| causes | | |
| 9) Age 18-24 | “yes” = 1; “no” = 0 | 1 |

According to various embodiments, a given algorithm generated by the predictive algorithm module 50 may be represented by the following equation (1) where the term “probability” refers to the goodness-of-fit score:

$$Probability = \frac{\begin{matrix}\begin{matrix}33.47 + 0.68 ( \begin{matrix}Value \\ of \\ Home\end{matrix} ) - 0.94 ( \begin{matrix}Time\_in \\ Current \\ Residence\end{matrix} ) - \\ 13.5 ( \begin{matrix}Purchases \\ Beauty \\ Aids\end{matrix} ) + 17.71 ( \begin{matrix}Subscribes \\ to\_Fitness \\ Magazine\end{matrix} ) -\end{matrix} \\ \begin{matrix}14.36 ( \begin{matrix}Reads \\ the \\ Bible\end{matrix} ) + 10.00 ( \begin{matrix}Surfs \\ the \\ Internet\end{matrix} ) - 20.94 ( \begin{matrix}Purchases \\ By\_Mail \\ Order\end{matrix} ) + \\ 9.07 ( \begin{matrix}Donates\_to \\ Environmental \\ Causes\end{matrix} ) + 11.67 ( \begin{matrix}Age \\ 18 - \\ 24\end{matrix} )\end{matrix}\end{matrix}}{100} \qquad ( 1 )$$

where the values of the non-attitudinal variables from Table 1 are inserted into the equation to calculate the goodness-of-fit score for the given individual for the given segment. Equation (1) is shown below with the inserted values as equation (2):

$$\begin{matrix}Probability = \frac{\begin{matrix}33.47 + 0.68 ( 147 ) - 0.94 ( 5 ) - 13.5 ( 0 ) + 17.71 ( 1 ) - \\ 14.36 ( 0 ) + 10.00 ( 1 ) - 20.94 ( 0 ) + 9.07 ( 0 ) + 11.67 ( 1 )\end{matrix}}{100} \\ = 78.146 \%\end{matrix} \qquad ( 2 )$$

According to other embodiments, a given predictive algorithm may be represented by an equation which only includes the numerator of equation (1). Of course, it will be appreciated that any number of different predictive algorithms may be utilized to calculate the respective goodness-of-fit scores. Stated differently, there are any number of different ways to calculate the respective goodness-of-fit scores.

Additionally, the validation module 52 may utilize the larger and smaller portions of the database to determine whether the performance of each of the respective predictive algorithms generated by the algorithm prediction module 50 is sufficiently acceptable.

From block 108, the process advances to block 110, where the prediction scoring module 54 utilizes the predictive algorithms to calculate, for each attitudinal segment, a goodness-of-fit score for each consumer listed in the database of the storage device 36. A given goodness-of-fit score calculated for a given consumer for a given segment at block 110 is a representation of that consumer's degree of fit with the given segment.

From block 110, the process advances to block 112, where the ranking module 56 ranks, on a segment by segment basis, all of the consumers listed in the database based on the goodness-of-fit scores calculated by the prediction scoring module 54 at block 110. The rankings represent the relative likelihood that the consumers will purchase a given product. Thus, it will be appreciated how the rankings could be utilized to identify a target list of potential consumers for given manufacturer, distributor, retailer, etc., where the target list includes fewer potential consumers than the number of potential consumers associated with the database. For example, according to various embodiments, the identified target list represents about 5% to 25% of all of the consumers listed in the database. However, it will be appreciated that the size of the target list may vary depending on marketing requirements and the level of predictive accuracy that is acceptable to a given manufacturer, distributor, retailer, etc.

From block 112, the process advances to block 114, where the screening module 58 determines, for each consumer on the targeted list, a likelihood that the consumer will visit a particular retailer (e.g., Home Depot). According to various embodiments, the screening module 58 may utilize any number of different screens (e.g., geographic screens, behavioral screens, attitudinal screens, etc.) to determine the respective likelihoods. Because the rankings determined at block 112 indicate, for each consumer listed in the database, the likelihood that the consumer will purchase a particular product, and because the screening module 58 determines, for each consumer on the list, the likelihood that a consumer will visit a particular retailer, it will be appreciated that following the completion of block 114, information is available which effectively indicates, for each consumer on the list, the likelihood that the consumer will purchase the particular product at the particular retailer.

Additionally, based on the respective likelihoods determined by the screening module 58 at block 114, it will be appreciated how the respective likelihoods could be utilized to finalize the above-described target list of potential consumers. For example, the target list of consumers could be re-ranked based on the likelihoods determined by the screening module 58, then the size of the targeted list could be finalized based on the re-rankings. The process described at blocks 102-114 may be repeated any number of times.

Nothing in the above description is meant to limit the invention to any specific materials, geometry, or orientation of elements. Many part/orientation substitutions are contemplated within the scope of the invention and will be apparent to those skilled in the art. The embodiments described herein were presented by way of example only and should not be used to limit the scope of the invention.

Although the invention has been described in terms of particular embodiments in this application, one of ordinary skill in the art, in light of the teachings herein, can generate additional embodiments and modifications without departing from the spirit of, or exceeding the scope of, the described invention. For example, according to various embodiments, the functionality of the screening module 58 can be incorporated into the functionality of the placement module 44, with the subsequent steps of the method 100 then utilizing information which has already been screened. Accordingly, it is understood that the drawings and the descriptions herein are proffered only to facilitate comprehension of the invention and should not be construed to limit the scope thereof.

What is claimed is:

1. A system, comprising:
a computing device, wherein the computing device comprises:
a processor; and
a screening module communicably connected to the processor, wherein the screening module is configured to determine a likelihood that a consumer will visit a retailer.

2. The system of claim 1, wherein the screening module is configured as a geographic screening module.

3. The system of claim 1, wherein the screening module is configured as a behavioral screening module.

4. The system of claim 1, wherein the screening module is configured as an attitudinal screening module.

5. A system, comprising:
a computing device, wherein the computing device comprises:
a processor;
a subgroup selection module communicably connected to the processor, wherein the subgroup selection module is configured to select a subgroup of consumers from a list of consumers;
a placement module communicably connected to the processor, wherein the placement module is configured to assign a consumer of the subgroup to a first segment;
a scoring module communicably connected to the processor, wherein the scoring module is configured to calculate a goodness-of-fit score for the consumer of the subgroup for the first segment;
a scoring prediction module communicably connected to the processor, wherein the scoring prediction module is configured to calculate a predicted goodness-of-fit score for another consumer from the list of consumers; and
a screening module communicably connected to the processor, wherein the screening module is configured to determine a likelihood that a consumer from the list of consumers will visit a retailer.

6. The system of claim 5, wherein the screening module is configured as a geographic screening module.

7. The system of claim 5, wherein the screening module is configured as a behavioral screening module.

8. The system of claim 5, wherein the screening module is configured as an attitudinal screening module.

9. The system of claim 5, wherein the placement module is further configured to identify an attitudinal dimension based on attitudinal data.

10. The system of claim 9, wherein the placement module is further configured to define different segments based on different attitudinal dimensions.

11. The system of claim 5, further comprising a significance module communicably connected to the processor, wherein the significance module is configured to determine a correlation between the goodness-of-fit score and one or more non-attitudinal variables associated with the consumer of the subgroup.

12. The system of claim 5, further comprising a validation module communicably connected to the processor, wherein the validation module is configured to determine a performance of a predictive algorithm.

13. A method, comprising:
receiving, at a computing device, information associated with a target list of consumers;
applying a screen to the target list, wherein the applying is performed by the computing device; and
finalizing the target list to include consumers who have a likelihood of visiting a retailer which is greater than a predetermined threshold, wherein the finalizing is performed by the computing device.

14. The method of claim 13, further comprising ranking the consumers on the target list.

15. A method, comprising:
receiving, at a computing device, data associated with a first plurality of consumers;
assigning a consumer of the first plurality of consumers to a first segment based on the received data, wherein the assigning is performed by the computing device;
calculating a goodness-of-fit score for the consumer of the first plurality of consumers for the first segment, wherein the calculating is performed by the computing device;
calculating a predicted goodness-of-fit score for a consumer of a second plurality of consumers for the first segment, the second plurality of consumers including at least the first plurality of consumers, wherein the calculating is performed by the computing device; and
screening at least some of the second plurality of consumers, wherein the screening is performed by the computing device.

16. The method of claim 15, wherein receiving data comprises receiving attitudinal data.

17. The method of claim 15, wherein assigning the consumer comprises assigning the consumer based on an attitudinal dimension associated with the received data.

18. The method of claim 15, wherein calculating the goodness-of-fit score comprises calculating the goodness-of-fit score based on at least one attitudinal dimension associated with the received data.

19. The method of claim 15, wherein calculating the predicted goodness-of-fit score comprises calculating the predicted goodness-of-fit score utilizing a predictive algorithm.

20. The method of claim 15, wherein the screening comprises screening the list of targeted consumers based on a geographic screen.

21. The method of claim 15, wherein the screening comprises screening the list of targeted consumers based on a behavioral screen.

22. The method of claim 15, wherein the screening comprises screening the list of targeted consumers based on an attitudinal screen.

23. The method of claim 15, further comprising defining at least one attitudinal dimension based on the received data, wherein the determining is performed by the computing device.

24. The method of claim 15, further comprising defining the first segment based on the received data, wherein the defining is performed by the computing device.

25. The method of claim 15, further comprising determining a correlation between the goodness-of-fit score and one or more non-attitudinal variables associated with the consumer of the first plurality of consumers, wherein the determining is performed by the computing device.

26. The method of claim 25, wherein determining the correlation comprises determining a cross-correlation between different non-attitudinal variables.

27. The method of claim 15, further comprising validating a performance of a predictive algorithm, wherein the validating is performed by the computing device.
